(19) United States
(12) Patent Application Publication
(10) Pub. No.: US 2023/0164195 A1
(43) Pub. Date: May 25, 2023

(54) Discovery and Control of a Media Device from Anywhere

(71) Applicant: Roku, Inc., San Jose, CA (US)

(72) Inventors: Badri SATHYA, San Jose, CA (US); Hari Venkata CHINNASWAMY, San Jose, CA (US); Kevin GONG, San Jose, CA (US); Tao WAN, San Jose, CA (US); Peter SANTANGELI, San Jose, CA (US)

(21) Appl. No.: 17/534,625

(22) Filed: Nov. 24, 2021

(51) Int. Cl. H04L 65/1059; H04L 65/1083; H04L 65/1073; H04L 65/61; G10L 15/22; G10L 15/08

(52) U.S. Cl. CPC H04L 65/1059; H04L 65/1083; H04L 65/1073; H04L 65/4069; G10L 15/22; G10L 15/08; G10L 2015/223; G10L 2015/088

(57) ABSTRACT

Disclosed herein are system, apparatus, article of manufacture, method and/or computer program product embodiments, and/or combinations and sub-combinations thereof, for discovery and control of a media device from anywhere using an electronic device. An example embodiment operates by receiving a command for controlling the media device from an application executing on an electronic device operating on a first network. The embodiment then generates a message comprising a device identifier for the media device and the command. The embodiment then determines that the device identifier is associated with a persistent network connection between a notification server and the media device. The embodiment then transmits, over the persistent network connection, the message to the media device, thereby causing the media device to execute the command, where the media device operates on a second network, and the second network is different from the first network.

### BACKGROUND

### Field

This disclosure is generally directed to discovery and control of a media device, and more particularly to discovery and control of a media device using an electronic device not connected to the same network as the media device.

### Background

A user often wants to discover and control a media device from anywhere using an electronic device. However, a user may not be able to discover and control the media device because the user's electronic device (e.g., a smartphone) is not connected to the same network (e.g., a WiFi™ network) as the media device. Moreover, the user's electronic device often cannot discover and control the media device even when it is connected to the same network as the media device. This may be because the electronic device performs discovery and control using an unreliable protocol (e.g., the user datagram protocol (UDP)). This may also be because of congestion on the network. This inability of a user to discover and control a media device from anywhere also presents the additional problem of preventing the user from retrieving state information from the media device from anywhere. For example, the user may want to find out how much time their kids are watching content on the media device when they are not at home. The user may also want to show what is being displayed by the media device to a remote technical support operator.

### SUMMARY

Provided herein are system, apparatus, article of manufacture, method and/or computer program product embodiments, and/or combinations and sub-combinations thereof, for discovery and control of a media device from anywhere. In contrast to existing approaches where an electronic device may be unable to discover and control media devices operating on a different network than the electronic device, embodiments described herein solve this technological problem by registering media devices with a system server and a notification server, and routing commands received from the electronic device through the system server to the notification server which transmits the commands to the registered media devices over persistent network connections with the registered media devices.

An embodiment is directed to system, apparatus, article of manufacture, method and/or computer program product embodiments, and/or combinations and sub-combinations thereof, for discovery and control of a media device from anywhere. In a non-limiting embodiment, the apparatus may be a server. The apparatus includes a memory and a processor that is communicatively coupled to the memory. In operation, in some embodiments, the processor receives a command for controlling a media device from an application executing on an electronic device operating on a first network. In response to receiving the command, the processor generates a message comprising a device identifier for the media device and the command. Then, the processor determines that the device identifier is associated with a persistent network connection between a notification server and the media device. Then, the processor transmits, over the persistent network connection maintained by the notification server, the message to the media device, thereby causing the media device to execute the command, where the media device operates on a second network, and the second network is different from the first network. In this case, a user is able to discover and control the media device even when the user is issuing commands to the media device using an electronic device not connected to the same network as the media device.

Another embodiment is directed to system, apparatus, article of manufacture, method and/or computer program product embodiments, and/or combinations and sub-combinations thereof, for discovery and control of a media device from anywhere using voice input. Again, in a non-limiting embodiment, the apparatus may be a server. The apparatus includes a memory and a processor communicatively coupled to the memory. In operation, in some embodiments, the processor receives a voice input for controlling a media device from an application executing on an electronic device operating on a first network. In response to receiving the voice input, the processor processes the voice input to generate a command (e.g., an intent). For example, the processor may perform one or more of secondary trigger word detection, automated speech recognition (ASR), natural language processing (NLP), and intent determination on the voice input. Then, the processor generates a message comprising a device identifier for the media device and the generated command (e.g., intent). Then, the processor determines that the device identifier is associated with a persistent network connection between a notification server and the media device. Then, the processor transmits, over the persistent network connection maintained by the notification server, the message to the media device, thereby causing the media device to execute the command (e.g., intent), where the media device operates on a second network, and the second network is different from the first network. In this case, a user is able to discover and control the media device using their voice even when the user gives voice input to the media device using an electronic device not connected to the same network as the media device.

### BRIEF DESCRIPTION OF THE FIGURES

The accompanying drawings are incorporated herein and form a part of the specification.

FIG. 1 illustrates a block diagram of a multimedia environment, according to some embodiments.

FIG. 2 illustrates a block diagram of a media device, according to some embodiments.

FIG. 3 illustrates a block diagram of a voice platform that analyzes voice input from an electronic device, according to some embodiments.

FIG. 4 is a flowchart illustrating a process for discovering and controlling a media device from anywhere, according to some embodiments.

FIG. 5 illustrates an example computer system useful for implementing various embodiments.

In the drawings, like reference numbers generally indicate identical or similar elements. Additionally, generally, the left-most digit(s) of a reference number identifies the drawing in which the reference number first appears.

### DETAILED DESCRIPTION

Provided herein are system, apparatus, device, method and/or computer program product embodiments, and/or combinations and sub-combinations thereof, for discovery and control of a media device from anywhere.

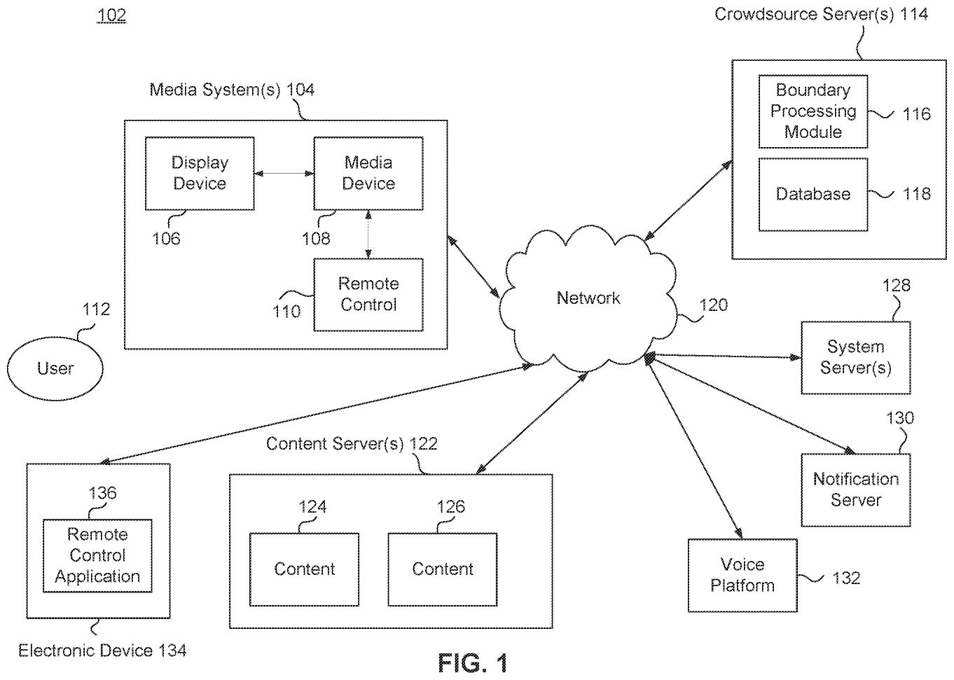

Various embodiments of this disclosure may be implemented using and/or may be part of a multimedia environment 102 shown in FIG. 1. It is noted, however, that multimedia environment 102 is provided solely for illustrative purposes, and is not limiting. Embodiments of this disclosure may be implemented using and/or may be part of environments different from and/or in addition to the multimedia environment 102, as will be appreciated by persons skilled in the relevant art(s) based on the teachings contained herein. An example of the multimedia environment 102 shall now be described.

### Multimedia Environment

FIG. 1 illustrates a block diagram of a multimedia environment 102, according to some embodiments. In a non-limiting example, multimedia environment 102 may be directed to streaming media. However, this disclosure is applicable to any type of media (instead of or in addition to streaming media), as well as any mechanism, means, protocol, method and/or process for distributing media.

The multimedia environment 102 may include one or more media systems 104. A media system 104 could represent a family room, a kitchen, a backyard, a home theater, a school classroom, a library, a car, a boat, a bus, a plane, a movie theater, a stadium, an auditorium, a park, a bar, a restaurant, or any other location or space where it is desired to receive and play streaming content. User(s) 112 may operate with the media system 104 to select and consume content.

Each media system 104 may include one or more media devices 108 each coupled to one or more display devices 106. It is noted that terms such as “coupled,” “connected to,” “attached,” “linked,” “combined” and similar terms may refer to physical, electrical, magnetic, logical, etc., connections, unless otherwise specified herein.

Media device 108 may be a streaming media device, DVD or BLU-RAY device, audio/video playback device, cable box, and/or digital video recording device, to name just a few examples. Display device 106 may be a monitor, television (TV), computer, smart phone, tablet, wearable (such as a watch or glasses), appliance, internet of things (IoT) device, and/or projector, to name just a few examples. In some embodiments, media device 108 can be a part of, integrated with, operatively coupled to, and/or connected to its respective display device 106.

Each media device 108 may be configured to communicate with network 120 via a communication device. The communication device may include, for example, a router or a cable modem or satellite TV transceiver. The media device 108 may communicate with the communication device over a link, wherein the link may include wireless (such as WiFi™) and/or wired connections.

In various embodiments, the network 120 can include, without limitation, wired and/or wireless intranet, extranet, Internet, cellular, Bluetooth, infrared, and/or any other short range, long range, local, regional, global communications mechanism, means, approach, protocol and/or network, as well as any combination(s) thereof.

Media system 104 may include a remote control 110. The remote control 110 can be any component, part, apparatus and/or method for controlling the media device 108 and/or display device 106, such as a remote control, a tablet, laptop computer, smartphone, wearable, on-screen controls, integrated control buttons, audio controls, or any combination thereof, to name just a few examples. In an embodiment, the remote control 110 wirelessly communicates with the media device 108 and/or display device 106 using cellular, Bluetooth, infrared, wireless (such as WiFi™), etc., or any combination thereof. The remote control 110 may include a microphone.

The multimedia environment 102 may include a plurality of content servers 122 (also called content providers or sources 122). Although only one content server 122 is shown in FIG. 1, in practice the multimedia environment 102 may include any number of content servers 122. Each content server 122 may be configured to communicate with network 120.

Each content server 122 may store content 124 and metadata 126. Content 124 may include any combination of music, videos, movies, TV programs, multimedia, images, still pictures, text, graphics, gaming applications, advertisements, programming content, public service content, government content, local community content, software, and/or any other content or data objects in electronic form.

In some embodiments, metadata 126 comprises data about content 124. For example, metadata 126 may include associated or ancillary information indicating or related to writer, director, producer, composer, artist, actor, summary, chapters, production, history, year, trailers, alternate versions, related content, applications, and/or any other information pertaining or relating to the content 124. Metadata 126 may also or alternatively include links to any such information pertaining or relating to the content 124. Metadata 126 may also or alternatively include one or more indexes of content 124, such as but not limited to a trick mode index.

The multimedia environment 102 may include one or more system servers 128. The system servers 128 may operate to support the media devices 108 from the cloud. It is noted that the structural and functional aspects of the system servers 128 may wholly or partially exist in the same or different ones of the system servers 128.

The media devices 108 may exist in thousands or millions of media systems 104. Accordingly, the media devices 108 may lend themselves to crowdsourcing embodiments and, thus, the multimedia environment 102 may include one or more crowdsource servers 114.

For example, using information received from the media devices 108 in the thousands and millions of media systems 104, the crowdsource server(s) 114 may identify similarities and overlaps between closed captioning requests issued by different users 112 watching a particular movie. Based on such information, the crowdsource server(s) 114 may determine that turning closed captioning on may enhance users' viewing experience at particular portions of the movie (for example, when the soundtrack of the movie is difficult to hear), and turning closed captioning off may enhance users' viewing experience at other portions of the movie (for example, when displaying closed captioning obstructs critical visual aspects of the movie). Accordingly, the crowdsource server(s) 114 may operate to cause closed captioning to be automatically turned on and/or off during future streaming of the movie.

Multimedia environment 102 may also include a voice platform 132. As noted above, the remote control 110 may include a microphone. The microphone may receive audio data from a user 112 (as well as other sources, such as the display device 106). In some embodiments, the media device 108 may be audio responsive, and the audio data may represent verbal commands from the user 112 to control the media device 108 as well as other components in the media system 104, such as the display device 106.

In some embodiments, the audio data received by the microphone in the remote control 110 is transferred to the media device 108, which is then forwarded to the voice platform 132. The voice platform 132 may operate to process and analyze the received audio data to recognize the user 112's verbal command. The voice platform 132 may then forward the verbal command back to the media device 108 for processing.

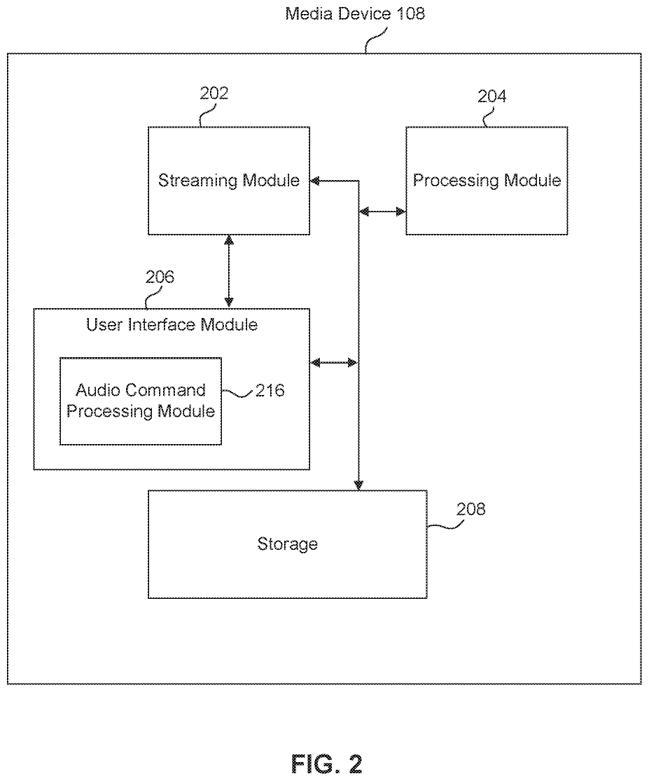

In some embodiments, the audio data may be alternatively or additionally processed and analyzed by an audio command processing module 216 in the media device 108 (see FIG. 2). The media device 108 and the system servers 128 may then cooperate to pick one of the verbal commands to process (either the verbal command recognized by the voice platform 132, or the verbal command recognized by the audio command processing module 206 in the media device 108).

The multimedia environment 102 may also include a notification server 130. Notification server 130 may send notifications to media devices 108. For example, notification server 130 may send a software update notification to a media device 108. Notification server 130 may send various other types of notifications as would be appreciated by a person of ordinary skill in the art.

Notification server 130 may be a push notification service. For example, notification server 130 may send a notification to a media device 108 where the request for the notification is triggered by notification server 130 rather than by an explicit request from media device 108.

Notification server 130 may maintain persistent network connections (e.g., using websocket) to media devices 108. Notification server 130 can send a notification to a media device 108 using the respective persistent network connection to the media device 108.

In some embodiments, the structural and functional aspects of the system server(s) 128, notification server 130, and voice platform 132 may wholly or partially exist in the same or different ones of the system server(s) 128, notification server 130, and voice platform 132. In some other embodiments, the structural and functional aspects of the crowdsource server(s) 114, content server(s) 122, system server(s) 128, notification server 130, and voice platform 132 may wholly or partially exist in the same or different ones of the crowdsource server(s) 114, content server(s) 122, system server(s) 128, notification server 130, and voice platform 132. In some other embodiments, the structural and functional aspects of the system server(s) 128, notification server 130, and voice platform 132 may exist in a cloud computing platform. In some other embodiments, the structural and functional aspects of the crowdsource server(s) 114, content server(s) 122, system server(s) 128, notification server 130, and voice platform 132 may exist in a cloud computing platform.

FIG. 2 illustrates a block diagram of an example media device 108, according to some embodiments. Media device 108 may include a streaming module 202, processing module 204, storage 208, and user interface module 206. As described above, the user interface module 206 may include the audio command processing module 216.

The media device 108 may also include one or more audio decoders and one or more video decoders. Each audio decoder may be configured to decode audio of one or more audio formats, such as but not limited to AAC, HE-AAC, AC3 (Dolby Digital), EAC3 (Dolby Digital Plus), WMA, WAV, PCM, MP3, OGG GSM, FLAC, AU, AIFF, and/or VOX, to name just some examples.

Similarly, each video decoder may be configured to decode video of one or more video formats, such as but not limited to MP4 (mp4, m4a, m4v, f4v, f4a, m4b, m4r, f4b, mov), 3GP (3gp, 3gp2, 3g2, 3gpp, 3gpp2), OGG (ogg, oga, ogv, ogx), WMV (wmv, wma, asf), WEBM, FLV, AVI, QuickTime, HDV, MXF (OP1a, OP-Atom), MPEG-TS, MPEG-2 PS, MPEG-2 TS, WAV, Broadcast WAV, LXF, GXF, and/or VOB, to name just some examples. Each video decoder may include one or more video codecs, such as but not limited to H.263, H.264, HEV, MPEG1, MPEG2, MPEG-TS, MPEG-4, Theora, 3GP, DV, DVCPRO, DVCPRO, DVCProHD, IMX, XDCAM HD, XDCAM HD422, and/or XDCAM EX, to name just some examples.

Now referring to both FIGS. 1 and 2, in some embodiments, the user 112 may interact with the media device 108 via, for example, the remote control 110. For example, the user 112 may use the remote control 110 to interact with the user interface module 206 of the media device 108 to select content, such as a movie, TV show, music, book, application, game, etc. The streaming module 202 of the media device 108 may request the selected content from the content server(s) 122 over the network 120. The content server(s) 122 may transmit the requested content to the streaming module 202. The media device 108 may transmit the received content to the display device 106 for playback to the user 112.

In streaming embodiments, the streaming module 202 may transmit the content to the display device 106 in real time or near real time as it receives such content from the content server(s) 122. In non-streaming embodiments, the media device 108 may store the content received from content server(s) 122 in storage 208 for later playback on display device 106.

Discovery and Control of a Media Device from Anywhere

A user often wants to discover and control a media device from anywhere using an electronic device. However, a user may not be able to discover and control the media device because the user's electronic device (e.g., a smartphone) is not connected to the same network (e.g., a WiFi™ network) as the media device. Moreover, the user's electronic device often cannot discover and control the media device even when it is connected to the same network as the media device. This is may be because the electronic device performs discovery and control using an unreliable protocol (e.g., UDP). This may also be because of congestion on the network. This inability of a user to discover and control a media device from anywhere also presents the additional problem of preventing the user from retrieving state information from the media device from anywhere. For example, the user may want to find out how much time their kids are watching content on the media device when they are not at home. The user may also want to show what is being displayed by the media device to a remote technical support operator.

Referring to FIG. 1, user 112 may use electronic device 134 to discover and control a media device 108 while the media device 108 operates on a different network than electronic device 134. For example, electronic device 134 may operate on a cellular network and the media device 108 may operate on a WiFi™ network. Electronic device 134 and the media device 108 may operate on various other types of networks as would be appreciated by a person of ordinary skill in art. In some embodiments, electronic device 134 transmits a command to system server 128. System server 128 then generates a message comprising a device identifier for the media device 108 and the command. System server 128 then sends the message to notification server 130 for transmission to the media device 108 for execution of the command.

In some embodiments, user 112 may use remote control application 136 to discover and control a media device 108. However, user 112 may not be able to use remote control application 136 to discover and control the media device 108 in various circumstances. For example, remote control application 136 may not be able to control a media device 108 that is outside its immediate vicinity. This may be because remote control application 136 uses a short-range communication protocol such as Bluetooth®, WiFi®, or infrared. This may also be because remote control application 136 may use a discovery protocol (e.g., Simple Service Discovery Protocol (SSDP)) that is designed to operate in a local area network (LAN).

Moreover, remote control application 136 may not be able to control a media device 108 in its immediate vicinity. This is because remote control application 136 may communicate with the media device 108 using an unreliable protocol (e.g., UDP). This may also be because remote control application 136 may communicate across a network (e.g., a WiFi™ network) that suffers from heavy congestion, and therefore drops a significant amount of packets.

In view of the above technological problems, a user 112 would like to be able to use a single electronic device 134 to discover and control different media devices 108 operating on a different network than the electronic device 134. This inability of the user 112 to use a single electronic device 134 to discover and control different media devices 108 from anywhere presents the additional problem of preventing the user 112 from retrieving state information from the media device 108 from anywhere. For example, the user 112 may want find out how much time their kids are watching content on the media device 108 when the user 112 is not at home. The user 112 may also want to show what is being displayed by the media device 108 to a remote technical support operator.

In some embodiments that solve these technological problems, a user 112 can select a command from remote control application 136 operating on an electronic device 134. In response to the selection, the electronic device 134 transmits the selected command to system server 128. System server 128 then generates a message comprising a device identifier for a media device 108 and the command. System server 128 then sends the message to notification server 130 for transmission to the media device 108 for execution of the command.

In some embodiments, prior to using the electronic device 134 to discover and control the media device 108, user 112 can register one or more media devices 108 (e.g., including the media device 108 that the user 112 wants to control) with system server 128. System server 128 can receive a registration request from user 112 via the electronic device 134. The registration request can include a device identifier for a media device 108. The device identifier can be an electronic serial number (ESN). The registration request can also include a device type of the media device 108. System server 128 can associate the device identifier for the media device 108 with the device type of the media device 108 and a user profile of user 112.

In some embodiments, media device 108 can also register itself with notification server 130. After completing the registration process, notification server 130 may establish a persistent network connection (e.g., using websocket) with the media device 108. Notification server 130 can send a notification to the media device 108 using the persistent network connection. If the media device 108 gets a new network address (e.g., a new Internet Protocol (IP) address), the media device 108 can re-register itself with notification server 130. Notification server 130 can then establish a new persistent network connection with the media device 108.

In some embodiments, once user 112 has registered one or media devices 108 with system server 128, the user 112 can control these one or more media devices 108 using electronic device 134. Because the user 112 has registered the one or more media devices 108 with system server 128, electronic device 134 does not need to use a discovery protocol (e.g., SSDP) to discover the one or more media devices 108 on a network (e.g., a LAN). Similarly, because notification server 130 maintains persistent network connections with the one or more media devices 108, electronic device 134 does not need to use a discovery protocol (e.g., SSDP) to discover the one or more media devices 108 on the network. Moreover, because the user 112 has registered a device type for each media device 108 with system server 128, electronic device 134 does not need to use a discovery protocol (e.g., SSDP) to discover the capabilities of the one or more media devices 108.

In some embodiments, system server 128 configures the electronic device 134 to issue commands to media device 108. In some embodiments, the user 112 can use remote control application 136 to login to system server 128. For example, the user 112 can enter their username and password in the remote control application 136 to authenticate themselves to system server 128. Remote control application 136 can then provide the username and password to system server 128 for authentication of the user 112.

In some embodiments, after logging into system server 128, remote control application 136 can retrieve a list of media devices 108 registered with the user 112 from system server 128. Remote control application 136 can display the list of media devices 108 registered with the user 112. Remote control application 136 can also display the device type of each of the listed media devices 108.

In some embodiments, the user 112 can select a media device 108 to control from the retrieved list of media devices 108 registered with the user 112. For example, the user 112 can select a streaming stick media device 108 that is present in her living room. The user 112 can select the media device 108 based on its device identifier.

In some embodiments, in response to selecting a particular media device 108, system server 128 can provide a list of commands that the selected media device 108 is capable of performing to remote control application 136. For example, some media devices 108 may be capable of performing basic commands such as keydown, keyup, keypress, play, and pause. Other media devices 108 may be capable of performing more advanced commands such as power, volume, home, search, and sleep. Remote control application 136 can customize the commands it can issue to the selected media device 108 based on the list of commands provided by system server 128. Remote control application 136 can also customize its user interface (UI) to display only commands capable of being performed by the selected media device 108.

In some embodiments, after the remote control application 136 is customized based on the selected media device 108, the user 112 can issue commands to the selected media device 108 using remote control application 136.

In some embodiments, the user 112 can issue external control protocol (ECP) commands to the selected media device 108. In the case of using remote control application 136 to control a media device 108, in an example embodiment, remote control application 136 can issue an ECP command to the media device 108 via a RESTful application programming interface (API) at the media device 108. For example, remote control application 136 can access the RESTful API at the media device 108 via HTTP (e.g., on port 8060). However, this may not be the case when using electronic device 134 to discover and control a media device 108 that operates on a different network than electronic device 134. In other words, electronic device 134 may not be able to directly issue an ECP command to the selected media device 108. This may be because the network address of the selected media device 108 is not publicly accessible to the electronic device 134.

To solve this technological problem, user 112 can use remote control application 136 to issue commands to the selected media device 108 through system server 128 and notification server 130. In some embodiments, in response to user 112 selecting a command at remote control application 136, the remote control application 136 can issue the corresponding ECP command to system server 128 via a RESTful API at system server 128. Remote control application 136 can access the RESTful API at the system server 128 via HTTP (e.g., on port 80). In some other embodiments, in response to user 112 selecting a command at remote control application 136, the remote control application 136 can issue the selected command to system server 128 via various other mechanisms as would be appreciated by a person of ordinary skill in the art.

In some embodiments, system server 128 can generate a message in response to receiving the command. System server 128 can generate the message such that the message represents the received command. System server 128 can also generate the message based on the device identifier associated with the selected media device 108. System server 128 can also generate the message based on the device type of the selected media device 108. System server 128 can also generate the message based on the type of the selected command.

In some embodiments, system server 128 can generate the message such that the message includes the received command. System server 128 can also generate the message such that it includes the device identifier (e.g., Electronic Serial Number (ESN)) of the selected media device 108.

In some embodiments, system server 128 can generate the message such that it includes a hold-for-pickup flag. System server 128 can set the hold-for-pickup flag based on the type of the selected command (e.g., a play command). The hold-for-pickup flag can indicate to notification server 130 that the message is not to be discarded even if it has not transmitted to the selected media device 108 in a threshold amount of time.

In some embodiments, system server 128 can generate the message such that it includes a state return address. The state return address can represent a network address for receiving state information from the selected media device 108 (e.g., what the selected media device 108 is currently displaying). System server 128 can set the state return address based on the type of the selected command (e.g., a diagnostic command). System server 128 can also set the state return address based on input provided by user 112 when selecting the command.

In some embodiments, system server 128 can generate the message in various data formats. For example, system server 128 can generate the message as a JavaScript Object Notation (JSON) message. System server 128 can also generate the message as an Extensible Markup Language (XML) message.

In some embodiments, after generating the message representing the selected command, system server 128 can send the message to notification server 130 for delivery to the selected media device 108.

In some embodiments, system server 128 and notification server 130 may be the same server. In this case, system server 128 can send the message directly to notification server 130 using various mechanisms (e.g., inter-process communication (IPC)). In some other embodiments, system server 128 and notification server 130 may be part of the same cloud-computing platform. In some other embodiments, system server 128 and notification server 130 may be separate servers. In these later two cases, system server 128 can send the message to notification server 130 using a networking communication mechanism.

In some embodiments, notification server 130 can receive the generated message from system server 128. Notification server 130 can then process the generated message for distribution to the selected media device 108 for execution of the command.

In some embodiments, notification server 130 can determine if the generated message is associated with a persistent network connection between notification server 130 and a media device 108. For example, notification server 130 can determine if the generated message contains a device identifier associated with a persistent network connection between notification server 130 and a media device 108. Notification server 130 may maintain this persistent network connection with the media device 108. If notification server 130 determines the generated message is associated with a persistent network connection between notification server 130 and a media device 108, notification server 130 can transmit the generated message to the media device 108 using the respective persistent network connection.

In some embodiments, notification server 130 may maintain a queue for each media device 108 registered with notification server 130. For example, notification server 130 may maintain a queue for each registered media device 108 based on the device identifier of each media device 108.

In some embodiments, notification server 130 may insert the generated message into a queue that corresponds to the media device 108 indicated in the generated message. The queue that the generated message is inserted into may be associated with a corresponding persistent network connection with the media device 108.

In some embodiments, notification server 130 may determine the queue in which to insert the generated message by looking up the device identifier contained in the generated message in a table that maps the device identifier to the queue. If there is no mapping, notification server 130 can skip inserting the message into a queue.

In some embodiments, system server 128 can insert the generated message into the appropriate queue based on the device identifier of the selected media device 108. This can avoid system server 128 having to include the device identifier in the generated message.

In some embodiments, notification server 130 may process messages inserted into a queue for a media device 108 in a first-in, first-out (FIFO) order. For example, if notification server 130 first inserts a message representing a play command into the queue, and then inserts a message representing a stop command into the queue, notification server 130 can send the message representing the play command to the selected media device 108 first.

In some embodiments, notification server 130 may filter messages prior to inserting them into the queue. In some other embodiments, notification server 130 may filter messages already inserted into the queue. For example, if the queue contains five consecutive messages each representing a play command, notification server 130 may remove four out of the five messages from the queue since those messages are redundant.

In some embodiments, notification server 130 may filter messages already inserted into the queue based on a state of the selected media device 108. For example, if the selected media device 108 is turned off (and therefore there is no persistent network connection between the notification server 130 and the selected media device 108), notification server 130 may remove messages from the corresponding queue that do not make sense to process (e.g., a play command).

In some embodiments, notification server 130 may filter messages that have been stored in the queue for more than a threshold amount of time. Notification server 130 may skip filtering a message stored in the queue for more than a threshold amount of time based on information in the message. For example, notification server 130 may skip filtering a message stored in the queue for more than a threshold amount of time if the message's hold-for-pickup flag is set.

In some embodiments, notification server 130 can transmit each message in the queue in turn to the selected media device 108. Notification server 130 can transmit each message using the persistent network connection it maintains with the selected media device 108. Notification server 108 may maintain a persistent network connection with each media device 108 so that it can push notifications to each media device 108 as needed. Notification server 130 may associate a corresponding persistent network connection with each queue.

In some embodiments, notification server 130 can transmit each message in its original format (e.g., JSON) to the selected media device 108. The selected media device 108 can then process the received message.

In some embodiments, the selected media device 108 can use a state return address in the received message to transmit state information about itself to another source represented by the state return address (e.g., a technical support operator or an electronic device 134 operated by a parent interested in tracking their kids viewing habits).

In some embodiments, a user 112 may want to use their voice to control the selected media device 108. In some embodiments for solving this technological problem, the user 112 can give voice input to a microphone communicatively coupled to electronic device 134. Electronic device 134 can then transmit the voice input to voice platform 132. Voice platform 132 can then generate a message representing the voice input and send the message to notification server 130 for transmission to the media device 108 for execution of the voice input.

In some embodiments, after the remote control application 136 is customized based on the selected media device 108, the user 112 can give voice input to a microphone communicatively coupled to electronic device 134. Electronic device 134, using remote control application 136, may preprocess the voice input prior to sending the voice input to voice platform 132. For example, in some embodiments, electronic device 134 may perform one or more of echo cancellation, trigger word detection, and noise cancellation on the voice input. After preprocessing the voice input, electronic device 134 may send the preprocessed voice input to voice platform 132.

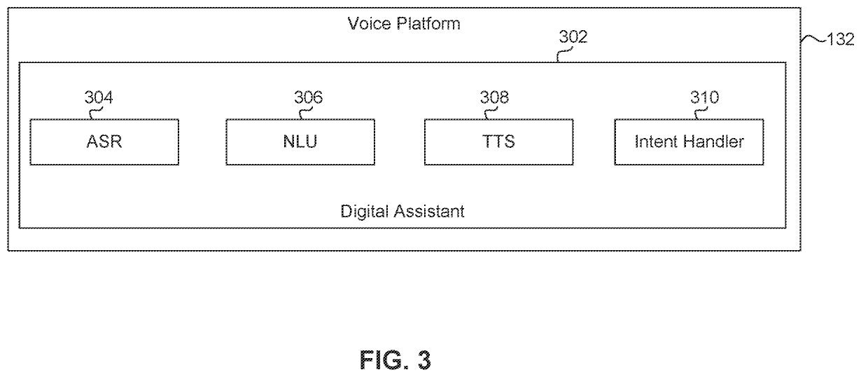

FIG. 3 illustrates a block diagram of a voice platform 132 that analyzes voice input from electronic device 134, according to some embodiments. In a non-limiting example, voice platform 132 may be directed to streaming media. However, this disclosure is applicable to any type of media (instead of or in addition to streaming media), as well as any mechanism, means, protocol, method and/or process for distributing media. FIG. 3 is discussed with reference to FIG. 1, although this disclosure is not limited to that example embodiment.

In some embodiments, voice platform 132 may process the voice input from electronic device 134. In some embodiments, voice platform 132 may include one or more digital assistants 302. In some embodiments, a digital assistant 302 is an intelligent software agent that can perform tasks for user 112. In some embodiments, voice platform 132 may select a digital assistant 302 to process the voice input based on a trigger word in the voice input. In some embodiments, a digital assistant 302 may have a unique trigger word.

In some embodiments, voice platform 132 may be implemented in a cloud computing platform. In some other embodiments, voice platform 132 may be implemented on a server computer. In some embodiments, voice platform 132 may be operated by a third-party entity. In some embodiments, electronic device 134 may send the voice input to voice platform 132 at the third-party entity based on detection of a trigger word in the voice input and or configuration information.

In some embodiments, voice platform 132 may perform one or more of secondary trigger word detection, automated speech recognition (ASR), natural language processing (NLP), and intent determination. The performance of these functions by voice platform 132 may enable electronic device 134 to utilize a low power processor (e.g., a DSP) with reduced memory capacity while still providing reliable voice command control.

In some embodiments, voice platform 132 may perform a secondary trigger word detection on the received voice input. For example, voice platform 132 may perform a secondary trigger word detection when electronic device 134 detects a trigger word with a low confidence value. This secondary trigger word detection may improve trigger word detection accuracy.

In some embodiments, voice platform 132 may select a digital assistant 302 based on the detected trigger word. In some embodiments, voice platform 132 may select a digital assistant 302 based on lookup table that maps trigger words to a particular digital assistant 180. Voice platform 132 may then dispatch the voice input to the selected digital assistant 302 for processing.

In some embodiments, a digital assistant 302 may process the voice input as commands. In some embodiments, a digital assistant 302 may provide a response to electronic device 134 via network 120 for delivery to user 112.

In the example of FIG. 3, voice platform 132 includes a digital assistant 302. In the example of FIG. 3, digital assistant 180 includes an ASR 304, NLU 306, and a text-to-speech (TTS) unit 308. In some other embodiments, voice platform 132 may include a common ASR 304 for one or more digital assistants 302.

In some embodiments, digital assistant 302 receives the voice input from electronic device 134 at ASR 304. In some embodiments, digital assistant 302 may receive the voice input as a pulse-code modulation (PCM) voice stream. As would be appreciated by a person of ordinary skill in the art, digital assistant 302 may receive the voice input in various other data formats.

In some embodiments, ASR 304 may detect an end-of-utterance in the voice input. In other words, ASR 304 may detect when a user 112 is done speaking. This may reduce the amount of data to analyze by NLU 306.

In some embodiments, ASR 304 may determine which words were spoken in the voice input. In response to this determination, ASR 304 may output text results for the voice input. Each text result may have a certain level of confidence. For example, in some embodiments, ASR 304 may output a word graph for the voice input (e.g., a lattice that consists of word hypotheses).

In some embodiments, NLU 306 receives the text results from ASR 304. In some embodiments, NLU 306 may generate a meaning representation of the text results through natural language understanding techniques as would be appreciated by a person of ordinary skill in the art.

In some embodiments, NLU 306 may generate an intent through natural language understanding techniques as would be appreciated by a person of ordinary skill in the art. In some embodiments, an intent may be a data structure that represents a task, goal, or outcome requested by a user 112. For example, a user 112 may say “Hey Assistant, play jazz on music application on my television.” In response, NLU 306 may determine that the intent of user 112 is to play jazz on an application (e.g., the music application) on display device 106. In some embodiments, the intent may be specific to NLU 306. This is because a particular digital assistant 302 may provide NLU 306.

In some embodiments, intent handler 310 may receive an intent from NLU 306. In some embodiments, intent handler 310 may convert the intent into a standard format. For example, in some embodiments, intent handler 310 may convert the intent into a standard format for media device 108. In some other embodiments, intent handler 310 may convert the intent into a message for delivery to notification server 130 for transmission to media device 108.

In some embodiments, intent handler 310 may convert the intent into a fixed number of intent types. In some embodiments, this may provide faster intent processing for media device 108.

In some embodiments, intent handler 310 may refine an intent based on information in a cloud computing platform. For example, in some embodiments, user 112 may say “Hey Assistant, play jazz.” In response, NLU 306 may determine that the intent of user 112 is to play jazz. Intent handler 310 may further determine an application for playing jazz. For example, in some embodiments, intent handler 310 may search a cloud computing platform for an application that plays jazz. Intent handler 310 may then refine the intent by adding the determined application to the intent.

In some embodiments, intent handler 310 may add other types of metadata to an intent. For example, in some embodiments, intent handler 310 may resolve a device name in an intent. For example, intent handler 310 may refine an intent of “watch NBA basketball on my TV” to an intent of “watch NBA basketball on <ESN=7H1642000026>”.

In some embodiments, intent handler 310 may add search results to an intent. For example, in response to “Show me famous movies”, intent handler 310 may add search results such as “Star Wars” and “Gone With the Wind” to the intent.

In some embodiments, voice platform 132 may overrule the selected digital assistant 302. For example, voice platform 132 may select a different digital assistant 302 than is normally selected based on the detected trigger word. Voice platform 132 may overrule the selected digital assistant 302 because some digital assistants 302 may perform certain types of tasks better than other digital assistants 302. For example, in some embodiments, voice platform 132 may determine that the digital assistant 302 selected based on the detected trigger word does not perform the requested task as well as another digital assistant 302. In response, voice platform 132 may dispatch the voice input to the other digital assistant 302.

In some embodiments, voice platform 132 may overrule the selected digital assistant 302 based on crowdsourced data. In some embodiments, voice platform 132 may track what digital assistant 302 is most often used for certain types tasks. In some other embodiments, a crowdsource server may keep track of which digital assistants 302 are used for certain types of tasks. As would be appreciated by a person of ordinary skill in the art, voice platform 132 may track the usage of different digital assistants 302 using various criteria including, but not limited to, time of day, location, and frequency. In some embodiments, voice platform 132 may select a different digital assistant 302 based on this tracking. Voice platform 132 may then dispatch the voice input to this newly selected digital assistant 302 for processing.

For example, in some embodiments, a majority of users 112 may use a digital assistant 302 from a first company to look up general information. However, a user 112 may submit a voice input of “Hey Second Assistant, what is the capital of Minnesota?” that would normally be processed by a second company's digital assistant 302 due to the user 112's use of the trigger word “Hey Second Assistant.” However, in some embodiments, voice platform 132 may consult a crowdsource server (e.g., crowdsource server 114) to determine if another digital assistant 302 should be used instead. The voice platform 132 may then send the voice input to the first company's digital assistant 302 (rather than the second company's digital assistant 302), if the crowdsource data indicates that typically such general information queries are processed by the first company's digital assistant 302.

In some embodiments, the crowdsource server (e.g., crowdsource server 114) may record the user 112's original request for the second company's digital assistant to perform the lookup. For example, the crowdsource server (e.g., crowdsource server 114) may increment a second company's digital assistant counter relating to general information queries by one. In the future, if a majority of users request the second company's digital assistant to process general information queries (such that second company's digital assistant's counter becomes greater than the first company's digital assistant and the counters of other digital assistants 302), then the voice platform 132 will dispatch such queries to the second company's digital assistant for processing (rather than the first company's digital assistant digital assistant).

In some embodiments, voice platform 132 may generate a message including the generated intent. Voice platform 132 may then send the generated message to notification server 130. For example, in some embodiments, a digital assistant 302 in voice platform 132 may generate a message including the generated intent and send the generated message to notification server 130. Notification server 130 may transmit the message to the selected media device 108.

In some embodiments, voice platform 132 may generate the message in the same format as the message generated for other commands as discussed above. For example, voice platform 132 can generate the message such that it includes the device identifier (e.g., ESN) of the selected media device 108. Voice platform 132 can also generate the message such that it includes a hold-for-pickup flag. Voice platform 132 can set the hold-for-pickup flag based on the type of the intent. Voice platform 132 can also generate the message such that it includes a state return address. The state return address can represent a network address that can receive state information about the selected media device 108 (e.g., what the selected media device 108 is currently displaying). Voice platform 132 can set the state return address based on the type of the intent. Voice platform 132 can also set the state return address based on voice input from user 112.

In some embodiments, voice platform 132 can generate the message in various data formats. For example, voice platform 132 can generate the message as a JSON message. Voice platform 132 can also generate the message as an XML message.

In some embodiments, after generating the message containing the intent, voice platform 132 can send the message to notification server 130 for delivery to the selected media device 108.

In some embodiments, voice platform 132 and notification server 130 may be the same server. In this case, voice platform 132 can send the message directly to notification server 130 using various mechanisms (e.g., inter-process communication (IPC)).

In some other embodiments, voice platform 132 and notification server 130 may be part of the same cloud-computing platform. In some other embodiments, voice platform 132 and notification server 130 may be separate servers. In these later two cases, voice platform 132 can send the message to notification server 130 using a networking communication mechanism.

In some embodiments, notification server 130 can receive the generated message from voice platform 132. Notification server 130 can then process the generated message for distribution to the selected media device 108 as discussed above.

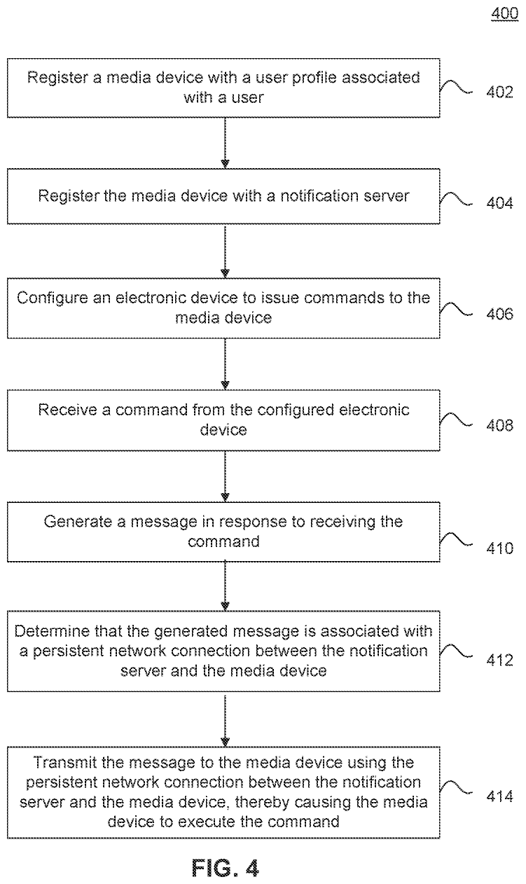

FIG. 4 illustrates a method 400 for discovering and controlling a media device from anywhere, according to some embodiments. Method 400 can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 4, as will be understood by a person of ordinary skill in the art.

For illustrative and non-limiting purposes, method 400 shall be described with reference to FIG. 1. However, method 400 is not limited to those examples.

In 402, system server 128 registers a media device 108 with a user profile associated with a user 112. In some embodiments, system server 128 can receive a registration request from the user 112 via electronic device 134. The registration request can include a device identifier for the media device 108. The device identifier can be an ESN. The registration request can also include a device type of the media device 108. System server 128 can associate the device identifier and the device type of the media device 108 with the user profile of the user 112.

In 404, notification server 130 registers the media device 108 with itself. In some embodiments, notification server 130 can receive a registration request from the media device 108. The registration request can include the device identifier for the media device 108. The device identifier can be an ESN.

In some embodiments, after completing the registration process, notification server 130 may establish a persistent network connection (e.g., using HTTPS) with the media device 108. Notification server 130 can send a notification to the media device 108 using the persistent network connection. If the media device 108 gets a new network address (e.g., a new IP address), the notification server 130 can re-register the media device 108 with itself. Notification server 130 can then establish a new persistent network connection with the media device 108.

In 406, system server 128 configures the electronic device 134 to issue commands to the media device 108. In some embodiments, the user 112 can use remote control application 136 to login to system server 128. For example, the user 112 can enter their username and password in the remote control application 136 to authenticate themselves to system server 128. Remote control application 136 can then provide the username and password to system server 128 for authentication of the user 112.

In some embodiments, after logging into system server 128, remote control application 136 can retrieve a list of media devices 108 registered with the user 112 from system server 128. Remote control application 136 can display the list of media devices 108 registered with the user 112. Remote control application 136 can also display the device type of each of the listed media devices 108.

In some embodiments, the user 112 can select a media device 108 to control from the retrieved list of media devices 108 using remote control application 136. For example, the user 112 can select a streaming stick media device 108 that is present in her living room using remote control application 136. The user 112 can select the media device 108 based on its device identifier.

In some embodiments, in response to selecting the media device 108, system server 128 can transmit a list of commands to remote control application 136 that the selected media device 108 is capable of performing. For example, some media devices 108 may be capable of performing basic commands such as keydown, keyup, and keypress. Other media devices 108 may be capable of performing more advanced commands such as play, pause, home, search, and sleep. Remote control application 136 can customize the commands it can issue to the selected media device 108 based on the list of commands it received from system server 128. Remote control application 136 can also customize its UI to display only commands that are capable of being performed by the selected media device 108.

In some embodiments, after the remote control application 136 is customized based on the selected media device 108, the user 112 can issue commands to the selected media device 108 using remote control application 136.

In 408, system server 128 receives a command from the user 112 via the configured electronic device 134 (e.g., using remote control application 136). In some embodiments, in response to the user 112 selecting the command at remote control application 136, the remote control application 136 can issue a corresponding ECP command to system server 128 via a RESTful API at system server 128. Remote control application 136 can access the RESTful API at the system server 128 via HTTP (e.g., on port 8060). In some other embodiments, in response to the user 112 selecting the command at remote control application 136, the remote control application 136 can issue the selected command to system server 128 via various other mechanisms as would be appreciated by a person of ordinary skill in the art.

In 410, system server 128 generate a message in response to receiving the command. System server 128 can generate the message such that the message represents the received command. System server 128 can also generate the message based on the device identifier associated with the selected media device 108. System server 128 can also generate the message based on the device type of the selected media device 108. System server 128 can also generate the message based on the type of the selected command.

In some embodiments, system server 128 can generate the message such that the message includes the received command. System server 128 can also generate the message such that it includes the device identifier (e.g., ESN) of the selected media device 108.

In some embodiments, system server 128 can generate the message such that it includes a hold-for-pickup flag. System server 128 can set the hold-for-pickup flag based on the type of the selected command (e.g., a play command). The hold-for-pickup flag can indicate to notification server 130 that the message is not to be discarded even if it has not transmitted to the selected media device 108 in a threshold amount of time.

In some embodiments, system server 128 can generate the message such that it includes a state return address. The state return address can represent a network address for receiving state information from the selected media device 108 (e.g., what the selected media device 108 is currently displaying). System server 128 can set the state return address based on the type of the selected command (e.g., a diagnostic command). System server 128 can also set the state return address based on input provided by user 112 when selecting the command.

In some embodiments, system server 128 can generate the message in various data formats. For example, system server 128 can generate the message as a JSON message. System server 128 can also generate the message as an XML message.

In 412, system server 128 (e.g., via or using notification server 130) determines that the generated message is associated with a persistent network connection between notification server 130 and the selected media device 108. For example, notification server 130 can determine if the generated message contains a device identifier associated with a persistent network connection between notification server 130 and the selected media device 108. Notification server 130 may maintain this persistent network connection with the selected media device 108. If notification server 130 determines the generated message is associated with a persistent network connection between notification server 130 and a media device 108, notification server 130 can transmit the generated message to the media device 108 using the respective persistent network connection.

In some embodiments, notification server 130 may maintain a queue for each media device 108 registered with notification server 130. For example, notification server 130 may maintain a queue for each registered media device 108 based on the device identifier of each media device 108.

In some embodiments, notification server 130 may insert the generated message into a queue that corresponds to the selected media device 108 indicated in the generated message. The queue that the generated message is inserted into may be associated with a corresponding persistent network connection with the media device 108.

In some embodiments, notification server 130 may determine the queue in which to insert the generated message by looking up the device identifier contained in the generated message in a table that maps the device identifier to the queue. If there is no mapping, notification server 130 can skip inserting the message into a queue.

In some embodiments, system server 128 can insert the generated message into the appropriate queue based on the device identifier of the selected media device 108.

In some embodiments, notification server 130 may process messages inserted into a queue for a media device 108 in a first-in, first-out (FIFO) order. For example, if notification server 130 first inserts a message representing a play command into the queue, and then inserts a message representing a stop command into the queue, notification server 130 can send the message representing the play command to the selected media device 108 first.

In 414, system server 128 (e.g., via or using notification server 130) transmits the message to the selected media device 108 using the persistent network connection between notification server 130 and the selected media device 108. This transmission of the message to the selected media device 108 can cause the selected media device 108 to execute the command.

In some embodiments, notification server 130 can transmit each message in the queue in turn to the selected media device 108. Notification server 130 can transmit each message using the persistent network connection it maintains with the selected media device 108.

In some embodiments, notification server 130 can transmit each message in its original format (e.g., JSON) to the selected media device 108. The selected media device 108 can then process the received message.

In some embodiments, the selected media device 108 can use a state return address in the received message to transmit state information about itself to another source represented by the state return address (e.g., a technical support operator or an electronic device 134 operated by a parent interested in tracking their kids viewing habits).

### Example Computer System

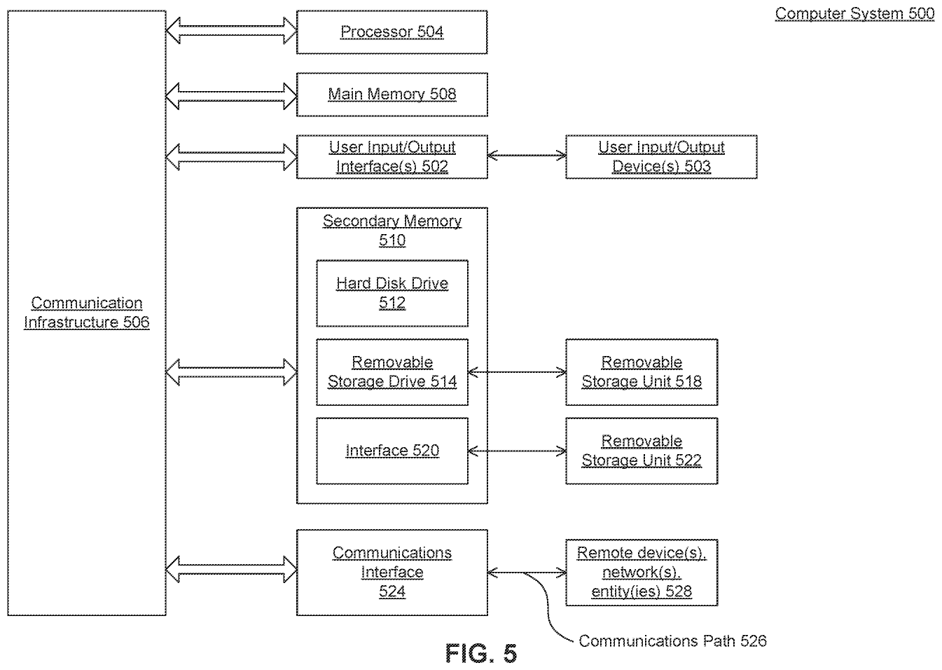

Various embodiments may be implemented, for example, using one or more well-known computer systems, such as computer system 500 shown in FIG. 5. For example, the media device 106 may be implemented using combinations or sub-combinations of computer system 500. Also or alternatively, one or more computer systems 500 may be used, for example, to implement any of the embodiments discussed herein, as well as combinations and sub-combinations thereof.

Computer system 500 may include one or more processors (also called central processing units, or CPUs), such as a processor 504. Processor 504 may be connected to a communication infrastructure or bus 506.

Computer system 500 may also include user input/output device(s) 503, such as monitors, keyboards, pointing devices, etc., which may communicate with communication infrastructure 506 through user input/output interface(s) 502.

One or more of processors 504 may be a graphics processing unit (GPU). In an embodiment, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 500 may also include a main or primary memory 508, such as random access memory (RAM). Main memory 508 may include one or more levels of cache. Main memory 508 may have stored therein control logic (i.e., computer software) and/or data.

Computer system 500 may also include one or more secondary storage devices or memory 510. Secondary memory 510 may include, for example, a hard disk drive 512 and/or a removable storage device or drive 514. Removable storage drive 514 may be a floppy disk drive, a magnetic tape drive, a compact disk drive, an optical storage device, tape backup device, and/or any other storage device/drive.

Removable storage drive 514 may interact with a removable storage unit 518. Removable storage unit 518 may include a computer usable or readable storage device having stored thereon computer software (control logic) and/or data. Removable storage unit 518 may be a floppy disk, magnetic tape, compact disk, DVD, optical storage disk, and/any other computer data storage device. Removable storage drive 514 may read from and/or write to removable storage unit 518.

Secondary memory 510 may include other means, devices, components, instrumentalities or other approaches for allowing computer programs and/or other instructions and/or data to be accessed by computer system 500. Such means, devices, components, instrumentalities or other approaches may include, for example, a removable storage unit 522 and an interface 520. Examples of the removable storage unit 522 and the interface 520 may include a program cartridge and cartridge interface (such as that found in video game devices), a removable memory chip (such as an EPROM or PROM) and associated socket, a memory stick and USB or other port, a memory card and associated memory card slot, and/or any other removable storage unit and associated interface.

Computer system 500 may further include a communication or network interface 524. Communication interface 524 may enable computer system 500 to communicate and interact with any combination of external devices, external networks, external entities, etc. (individually and collectively referenced by reference number 528). For example, communication interface 524 may allow computer system 500 to communicate with external or remote devices 528 over communications path 526, which may be wired and/or wireless (or a combination thereof), and which may include any combination of LANs, WANs, the Internet, etc. Control logic and/or data may be transmitted to and from computer system 500 via communication path 526.

Computer system 500 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 500 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 500 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 500, main memory 508, secondary memory 510, and removable storage units 518 and 522, as well as tangible articles of manufacture embodying any combination of the foregoing. Such control logic, when executed by one or more data processing devices (such as computer system 500 or processor(s) 504), may cause such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 5. In particular, embodiments can operate with software, hardware, and/or operating system implementations other than those described herein.

### CONCLUSION

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “one embodiment,” “an embodiment,” “an example embodiment,” or similar phrases, indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary embodiments, but should be defined only in accordance with the following claims and their equivalents.

1. A computer implemented method for discovering and controlling a media device, comprising:
receiving a selection of the media device from a remote control application executing on an electronic device, wherein the selection is by a user operating the remote control application, and the electronic device operates on a first network and the media device operates on a second network;
transmitting a subset of commands of a plurality of commands to the remote control application in response to receiving the selection of the media device, wherein the subset of commands are capable of being performed by the media device and are specific to a type of the media device;
receiving a command in the subset of commands for controlling the media device from the remote control application;
generating a message in response to receiving the command, wherein the message comprises a device identifier for the media device and the command;
determining that the device identifier is associated with a persistent network connection between a notification server and the media device, wherein the persistent network connection is maintained by the notification server; and
transmitting, over the persistent network connection, the message to the media device.

2. The computer implemented method of claim 1, further comprising:
receiving a login request from the remote control application executing on the electronic device, wherein the login request is for a user of the remote control application; and
transmitting a list of media devices registered with the user to the remote control application; and
wherein the receiving the selection of the media device further comprises receiving the selection of the media device in response to the transmitting the list of media devices registered with the user to the remote control application, wherein the selection comprises the device identifier for the media device.

3. The computer implemented method of claim 2, wherein a user interface of the remote control application executing on the electronic device is customized based on the subset of commands.

4. The computer implemented method of claim 1, wherein the message further comprises a state return address, and the state return address represents a network address for receiving state information from the media device.

5. The computer implemented method of claim 1, wherein the command is a voice input, and further comprising:
processing the voice input by performing one or more of trigger word detection, automated speech recognition (ASR), natural language processing (NLP), or intent determination; and
wherein the generating the message further comprises:
generating the message based on the processed voice input.

6. The computer implemented method of claim 1, further comprising:
registering the media device with the user of the remote control application.

7. The computer implemented method of claim 1, further comprising:
determining the device identifier corresponds to a queue associated with the media device;
inserting the message into the queue associated with the media device; and
wherein the transmitting the message to the media device further comprises transmitting the message in the queue to the media device.

8. A system for discovering and controlling a media device, comprising:
a memory; and
at least one processor coupled to the memory and configured to:
receive a selection of the media device from a remote control application executing on an electronic device, wherein the selection is by a user operating the remote control application, and the electronic device operates on a first network and the media device operates on a second network;
transmit a subset of commands of a plurality of commands to the remote control application in response to receiving the selection of the media device, wherein the subset of commands are capable of being performed by the media device and are specific to a type of the media device;
receive a command in the subset of commands for controlling the media device from the remote control application;
generate a message in response to receiving the command, wherein the message comprises a device identifier for the media device and the command;
determine that the device identifier is associated with a persistent network connection between a notification server and the media device, wherein the persistent network connection is maintained by the notification server; and
transmit, over the persistent network connection, the message to the media device.

9. The system of claim 8, wherein the at least one processor is further configured to:
receive a login request from the remote control application executing on the electronic device, wherein the login request is for a user of the remote control application; and
transmit a list of media devices registered with the user to the remote control application; and
wherein to receive the selection of the media device, the at least one processor is further configured to receive the selection of the media device in response to the transmitting the list of media devices registered with the user to the remote control application, wherein the selection comprises the device identifier for the media device.

10. The system of claim 9, wherein a user interface of the remote control application executing on the electronic device is customized based on the subset of commands.

11. The system of claim 8, wherein the message further comprises a state return address, and the state return address represents a network address for receiving state information from the media device.

12. The system of claim 8, wherein the command is a voice input, and wherein the at least one processor is further configured to:
process the voice input by performing one or more of trigger word detection, automated speech recognition (ASR), natural language processing (NLP), or intent determination; and
wherein to generate the message, the at least one processor is further configured to:
generate the message based on the processed voice input.

13. The system of claim 8, wherein the at least one processor is further configured to:
register the media device with the user of the remote control application.

14. The system of claim 8, wherein the at least one processor is further configured to:
determine the device identifier corresponds to a queue associated with the media device;
insert the message into the queue associated with the media device; and
wherein to transmit the message, the at least one processor is further configured to transmit the message in the queue to the media device.

15. A non-transitory computer-readable medium having instructions stored thereon that, when executed by at least one computing device, cause the at least one computing device to perform operations comprising:
receiving a selection of a media device from a remote control application executing on an electronic device, wherein the selection is by a user operating the remote control application, and the electronic device operates on a first network and the media device operates on a second network;
transmitting a subset of commands of a plurality of commands to the remote control application in response to receiving the selection of the media device, wherein the subset of commands are capable of being performed by the media device and are specific to a type of the media device;
receiving a command in the subset of commands for controlling the media device from the remote control application;
generating a message in response to receiving the command, wherein the message comprises a device identifier for the media device and the command;
determining that the device identifier is associated with a persistent network connection between a notification server and the media device, wherein the persistent network connection is maintained by the notification server; and
transmitting, over the persistent network connection, the message to the media device.

16. The non-transitory computer-readable medium of claim 15, the operations further comprising:
receiving a login request from the remote control application executing on the electronic device, wherein the login request is for a user of the remote control application; and
transmitting a list of media devices registered with the user to the remote control application; and
wherein the receiving the selection of the media device further comprises receiving the selection of the media device in response to the transmitting the list of media devices registered with the user to the remote control application, wherein the selection comprises the device identifier for the media device.

17. The non-transitory computer-readable medium of claim 16, wherein a user interface of the remote control application executing on the electronic device is customized based on the subset of commands.

18. The non-transitory computer-readable medium of claim 15, wherein the message further comprises a state return address, and the state return address represents a network address for receiving state information from the media device.

19. The non-transitory computer-readable medium of claim 15, wherein the command is a voice input, and the operations further comprising:
processing the voice input by performing one or more of trigger word detection, automated speech recognition (ASR), natural language processing (NLP), or intent determination; and
wherein the generating the message further comprises:
generating the message based on the processed voice input.

20. The non-transitory computer-readable medium of claim 15, the operations further comprising:
registering the media device with the user of the remote control application.
